(19) United States
(12) Patent Application Publication
(10) Pub. No.: US 2013/0271445 A1
(43) Pub. Date: Oct. 17, 2013

(54) DUAL MODE DISPLAY DEVICE

(71) Applicant: SAMSUNG DISPLAY CO., LTD., Yongin-City (KR)

(72) Inventors: JAE BYUNG PARK, Seoul (KR); HAEIL PARK, Seoul (KR); DONCHAN CHO, Seongnam-si (KR); SUNGTAE SHIN, Suwon-si (KR); Gilhwan YEO, Hwaseong-si (KR)

(73) Assignee: SAMSUNG DISPLAY CO., LTD., Yongin-City (KR)

(21) Appl. No.: 13/844,578

(22) Filed: Mar. 15, 2013

(30) Foreign Application Priority Data
Apr. 13, 2012 (KR) 10-2012-0038682

(51) Int. Cl. G09G 5/00

(52) U.S. Cl. CPC G09G 5/003
USPC 345/212; 345/87; 345/76

(57) ABSTRACT

A display device is capable of operating in a first mode and is capable of operating in a second mode. The display device includes a first image display unit that includes a photonic crystal layer, the photonic crystal layer being configured to be substantially transparent when the display device operates in the first mode and being configured to display at least an image when the display device operates in the second mode. The display device further includes a second image display unit overlapping the first image display unit and configured to turned on in the first mode to display at least an image and turned off in the second mode.

### CROSS-REFERENCE TO RELATED APPLICATION

This U.S. non-provisional patent application claims priority and benefit under 35 U.S.C. §119 of Korean Patent Application No. 10-2012-0038682, filed on Apr. 13, 2012, the contents of which are hereby incorporated by reference.

### BACKGROUND

1. Field of the Invention

The present invention relates to a display device. More particularly, the present invention relates to a display device capable of being operated in two modes.

2. Description of the Related Art

Display devices may be classified into self-light-emitting display devices and non-self-light-emitting display devices. Self-light-emitting display devices may include plasma display devices and organic light emitting display devices. Non-self-light-emitting display devices may include liquid crystal display devices, electrophoretic display devices, and electrowetting display devices. Whether a display is a self-light-emitting display device or a non-self-light-emitting device, when the display device is operated without an external light source, the display device typically consumes more power (or energy) then when the display device is operated with an external light source.

### SUMMARY

An embodiment of the invention is related to a display device capable of operating in a first mode and capable of operating in a second mode. The display device may include a first image display unit that includes a photonic crystal layer. The photonic crystal layer may be configured to be substantially transparent when the display device operates in the first mode and may be configured to display at least an image when the display device operates in the second mode. The display device may further include a second image display unit overlapping the first image display unit and configured to be turned on in the first mode to display at least an image and turned off in the second mode.

The display device operates in the first mode only when the ambient light available to the display device is insufficient for the first image display unit to display images with satisfactory image quality. When the ambient light is sufficient for the first image display unit to display images with satisfactory image quality, the display device operates in the second mode. Advantageously, power consumption of the display device may be minimized.

In one or more embodiments, the second image display unit may be configured to display one or more images when the display device operates in the first mode.

In one or more embodiments, the second image display unit may be configured to be non-operating when the first image display unit displays one or more images.

In one or more embodiments, the second image display unit may be configured to display a monochromatic image when the first image display unit displays one or more images.

In one or more embodiments, the first image display unit may include a first pixel electrode and a first common electrode. The first pixel electrode may be configured to receive a first data voltage. The first common electrode may overlap the first pixel electrode and may be configured to receive a first common voltage. At least a portion of the photonic crystal layer may be disposed between the first pixel electrode and the first common electrode. One of the first pixel electrode and the first common electrode may be disposed between the photonic crystal layer and the second image display device.

In one or more embodiments, the second image display unit may include a second pixel electrode and a second common electrode. The second pixel electrode may overlap the first pixel electrode and may be configured to receive a second data voltage. The second common electrode may be configured to receive a second common voltage. The portion of the photonic crystal layer may be disposed between one of the first pixel electrode and the first common electrode and at least one of the second pixel electrode and the second common electrode.

In one or more embodiments, the second pixel electrode may be configured to receive the second data voltage when the first image display unit is substantially transparent. The second pixel electrode may be configured to receive no data voltage when the first image display unit displays one or more images.

In one or more embodiments, the second image display unit may include an organic light emitting layer. One of the second pixel electrode and the second common electrode may be disposed between the photo crystal layer and the organic light emitting layer.

In one or more embodiments, the second image display unit may include a liquid crystal layer. One of the second pixel electrode and the second common electrode may be disposed between the photo crystal layer and the liquid crystal layer.

In one or more embodiments, the display device may further include a base substrate. One of the first pixel electrode and the first common electrode may be disposed on the base substrate. One of the second pixel electrode and the second common electrode may be disposed on the base substrate.

In one or more embodiments, the first data voltage may have a first voltage level when the display device operates in the first mode, the first data voltage may have a second voltage level when the display device operates in the second mode, and the first voltage level may be greater than the second voltage level.

In one or more embodiments, a difference between the first data voltage and the first common voltage may have a first absolute value when the display device operates in the first mode, the difference between the first data voltage and the first common voltage may have a second absolute value when the display device operates in the second mode, and the first absolute value may be greater than the second absolute value.

In one or more embodiments, the second image display unit may include an organic light emitting layer. One of the first pixel electrode and the first common electrode may be disposed between the photo crystal layer and the organic light emitting layer.

In one or more embodiments, the portion of the photonic crystal layer may be configured to reflect light of various wavelengths according to various values of a difference between the first data voltage and the first common voltage when the display device operates in the second mode.

In one or more embodiments, the display device may further include a light-emitting unit that is disposed closer to the second image display unit than to the first image display unit.

In one or more embodiments, the display device may be configured to be used by a viewer that is positioned closer to the first image display unit than to the second image display unit.

An embodiment of the invention is related to a display device capable of operating in a reflection mode or a transmission mode, wherein the transmission may not require existence of external light.

The display device includes a first image display unit that transmits a light in a first mode and reflects the light in a second mode to display an image, and a second image display unit turned on in the first mode to display the image and turned off in the second mode. The first image display unit includes a photonic crystal layer that transmits or reflects the light in accordance with an electric field applied thereto.

The first image display unit includes a plurality of first pixels, the second image display unit includes a plurality of second pixels, and the first pixels respectively correspond to the second pixels.

The first image display unit further includes a first electrode and a second electrode, and the first and second electrodes face each other while interposing the photonic crystal layer therebetween to apply the electric field to the photonic crystal layer. The photonic crystal layer provides the image in the second mode in accordance with the electric field formed by the first and second electrodes. The image has a white, red, green, or blue color to correspond to each of the first pixels.

In one or more embodiments, the second image display unit is a liquid crystal image display unit that includes a liquid crystal layer and electrodes applying an electric field to the liquid crystal layer. The electrodes include a third electrode and a fourth electrode, and the third and fourth electrodes face each other while interposing the liquid crystal layer therebetween.

In one or more embodiments, the second image display unit is an organic light emitting image display unit that comprises an organic light emitting layer and electrodes that drives the organic light emitting layer. The electrodes include a fifth electrode and a sixth electrode, and the fifth and sixth electrodes face each other while interposing the organic light emitting layer.

According to embodiments of the invention, the display device may operate in a reflection mode taking advantage of ambient light or operate in a transmission mode only when the available ambient light is insufficient, and thus power consumption of the display device may be minimized.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view illustrating a display device according to one or more embodiments of the present invention;

FIG. 2 is a cross-sectional view taken along a line I-I′ of FIG. 1;

FIG. 3A is a circuit diagram illustrating a portion of a first electronic device of the display device;

FIG. 3B is a circuit diagram illustrating a portion of a second electronic device of the display device;

FIG. 4 is a view for explaining operation of the first image display unit of the display device according to one or more embodiments of the present invention;

FIG. 5 is a cross-sectional view illustrating a display device operated in a transmission mode according to one or more embodiments of the present invention;

FIG. 6 is a cross-sectional view illustrating a display device operated in a reflection mode according to one or more embodiments of the present invention;

FIG. 7 is a cross-sectional view illustrating a display device according to one or more embodiments of the present invention; and

FIG. 8 is a cross-sectional view illustrating a display device according to one or more embodiments of the present invention.

### DETAILED DESCRIPTION

It will be understood that if a first element or layer is referred to as being “on”, “connected to”, or “coupled to” a second element or layer, the first element or layer can be directly on, directly connected to, or directly coupled to the second element or layer; additionally or alternatively, one or more intervening elements or layers may be present. In contrast, if a first element is referred to as being “directly on,” “directly connected to”, or “directly coupled to” a second element or layer, there are no intervening elements or layers present between the two elements or layers. Like numbers may refer to like elements throughout. As used herein, the term “and/or” may include any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer or section from another region, layer, or section. Thus, a first element, component, region, layer or section discussed below could be termed a second element, component, region, layer, or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

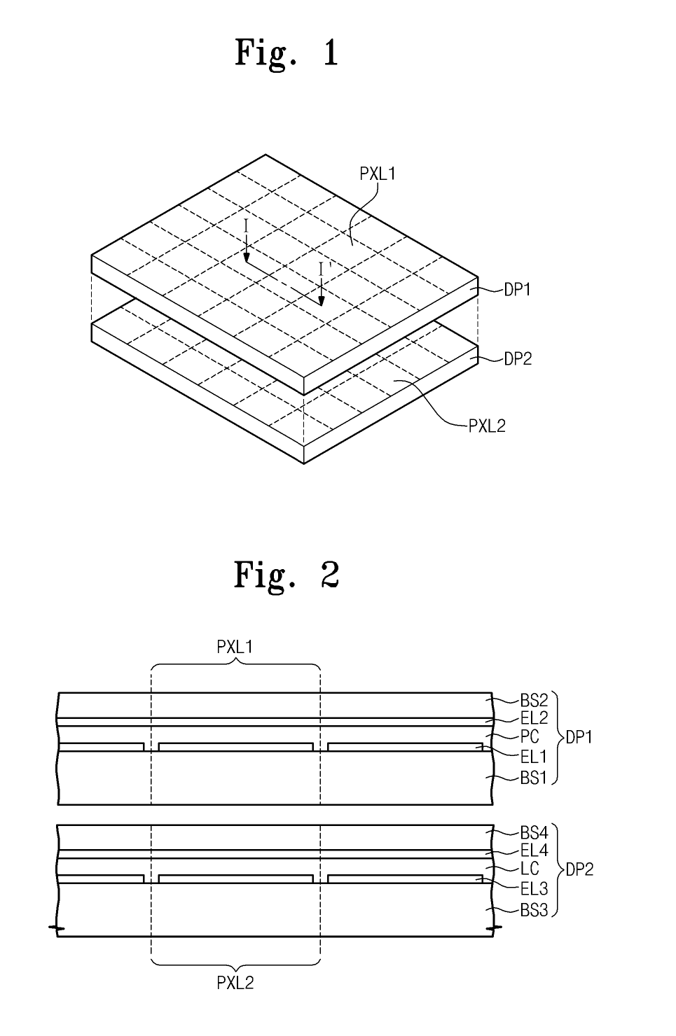

FIG. 1 is a perspective view illustrating a display device according to one or more embodiments of the present invention. FIG. 2 is a cross-sectional view taken along a line I-I′ of FIG. 1. The display device may be selectively operated in a reflection mode or a transmission mode.

Referring to FIGS. 1 and 2, the display device includes a first image display unit DP1 and a second image display unit DP2. The first image display unit DP1 and the second image display unit DP2 are stacked, and the first image display unit DP1 faces a viewer and is positioned between the viewer and the second image display unit DP2. A coupling member (not shown), e.g., an adhesive member, is provided between the first image display unit DP1 and the second image display unit DP2 to couple the first image display unit DP1 and the second image display unit DP2 to each other.

The first image display unit DP1 has a rectangular plate shape (with long sides and short sides) and includes a photonic crystal layer PC.

The first image display unit DP1 includes a plurality of pixels PXL1 arranged in a matrix form. The pixels PXL1 of the first image display unit DP1 are distinguished from pixels PXL2 of the second image display unit DP2.

The first image display unit DP1 includes a first base substrate BS1, a second base substrate BS2 facing the first base substrate BS1, the photonic crystal layer PC disposed between the first base substrate BS1 and the second base substrate BS2, and a first electronic device that is configured to drive the photonic crystal layer PC.

Each of the first base substrate BS1 and the second base substrate BS2 may include, for example, a silicon substrate, a glass substrate, or a plastic substrate. The first base substrate BS1 and the second base substrate BS2 may be formed of one or more transparent materials. In one or more embodiments, each pixel PXL1 includes a portion of the first base substrate BS1, a portion of the second base substrate BS2, a portion of the photonic crystal layer PC, and a portion of the first electronic device.

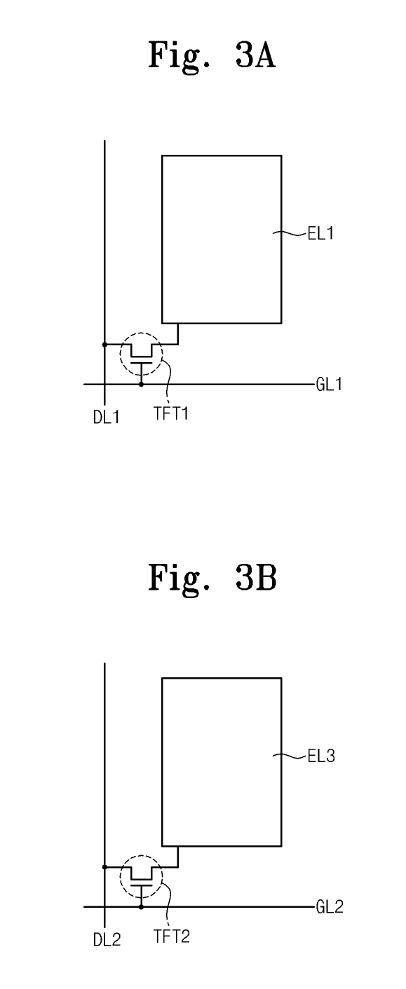

The portion of the first electronic device includes an electrode ELL a portion of an electrode EL2, and a thin film transistor TFT1 (illustrated in FIG. 3A) electrically connected to the electrode EL1. The electrode EL1 and the electrode EL2 are formed of one or more transparent conductive materials, such as one or more of indium tin oxide (ITO), indium zinc oxide (IZO), etc.

The electrode EL1 is disposed on the first base substrate BS1; the electrode EL2 is disposed on the second base substrate BS2. The electrode EL1 faces the electrode EL2 with a portion of the photonic crystal layer PC being disposed between the electrode EL1 and the electrode EL2. The electrode EL1 may be one of a plurality of electrodes ELL wherein the electrodes EL1 (pixel electrodes) correspond to the pixels PXL1, respectively. The electrode EL2 (a common electrode) corresponds to the plurality of electrodes EL1 and covers at least a substantial portion of the second base substrate BS2. The thin film transistor TFT1 (illustrated in FIG. 3A) is disposed on the first base substrate BS1 and is electrically connected to the electrode ELL

The display device may include signal lines configured to apply signals to the first electronic device. The signal lines may be configured to apply the signals to the thin film transistor TFT1 of the first electronic device.

FIG. 3A is a circuit diagram illustrating a portion of the first electronic device.

Referring to FIG. 3A, the signal lines may include a gate line GL1 and a data line DL1. The gate line GL1 extends in a first direction and is electrically connected to a gate electrode of the thin film transistor TFT1 to apply a gate signal to the gate electrode of the thin film transistor TFT1. The data line DL1 extends in a second direction crossing the first direction and is electrically connected to a source electrode of the thin film transistor TFT1 to apply a data signal to the source electrode of the thin film transistor TFT1. The thin film transistor TFT1 applies the data signal to the electrode EL1 in response to a gate-on signal, and thus a data voltage corresponding to the data signal is applied to the electrode ELL The electrode EL2 is applied with a common voltage when the data voltage is applied to the electrode EL1 through the thin film transistor TFT1; thus, an electric field is formed between the electrode EL1 and the electrode EL2.

The photonic crystal layer PC transmits or reflects light incident thereto in response to the electric field. The photonic crystal layer PC reflects a portion of the light, which has a specific wavelength, and transmits a remaining portion of the light, which has one or more other wavelengths, so as to display an image with a color. The photonic crystal layer PC includes particles having electric charges or an electric polarization property and includes a solvent. Accordingly, when the electric field is applied to the photonic crystal layer PC, a distance between the particles is controlled. As a result, the portion of the light having the specific wavelength is reflected by the photonic crystal layer PC, and the color image is displayed. That is, each pixel PXL1 displays a color, such as a white, red, green, or blue color, in accordance with the electric field formed between the electrode EL1 and the electrode EL2. Different pixels PXL1 may display different colors.

The particles have a negative (−) charge or a positive (+) charge and are colloidally dispersed in the solvent. In one or more embodiments, the particles have the same charge and are spaced apart from each other by a repulsive force generated between the particles.

The particles and/or the solvent in which the particles are dispersed have the electrical polarization property. The particles and/or the solvent are polarized by electronic polarization, ion polarization, interfacial polarization, or rotational polarization when the electric field is applied. In one or more embodiments, when no electric field is applied, the particles and/or the solvent are disorderly distributed, but the particles and/or the solvent are orderly arranged when the electric field is applied.

The particles may include particles made of one or more of silicon (Si), titanium (Ti), barium (Ba), strontium (Sr), iron (Fe), nickel (Ni), cobalt (Co), lead (Pb), aluminum (Al), copper (Cu), silver (Ag), gold (Au), tungsten (W), molybdenum (Mo), and/or particles made of one or more oxides of one or more of the aforementioned elements. Additionally or alternatively, the particles may include particles made of one or more polymer materials, such as one or more of polystyrene (PS), polyethylene (PE), polypropylene (PP), polyvinyl chloride (PVC), polyethylene terephthalate (PET), etc. In one or more embodiments, the particles may be configured to include particles having no charge and/or clusters coated with charges. The particles may have one or more of a core-shell structure, a multi-core structure, and a cluster structure including a plurality of nanoparticles; an electric charge layer may be disposed on one or more of the above-mentioned structures.

The solvent may include at least one of water, trichloroethylene, carbon tetrachloride, di-isopropyl ether, toluene, methyl-t-butyl ether, xylene, benzene, diethyl ether, dichloromethane, 1,2-dichloroethane, butyl acetate, iso-propanol, n-butanol, tetrahydrofuran, n-propanol, chloroform, ethyl acetate, 2-butanone, dioxane, acetone, methanol, ethanol, acetonitrile, acetic acid, dimethyl formamide, and dimethyl sulfoxide.

In one or more embodiments, the particles and the solvent should not be limited to the above-mentioned configuration, and the configuration of the particles and the solvent may be changed.

In one or more embodiments, the photonic crystal layer PC is formed in a single layer. In one or more embodiments, the photonic crystal layer PC may include a plurality of capsules formed of a light-transmitting material, wherein the particles and the solvent are capsulated in the capsules. The capsules are provided to respectively correspond to the pixels PXL1. In one or more embodiments, since the particles and the solvent are capsulated in each pixel PXL1, the capsulated particles and the capsulated solvent may be prevented from being mixed with the capsulated particles and the capsulated solvent in adjacent pixel PXL1s. In one or more embodiments, even if an electric field difference occurs between adjacent pixels PXL1, the particles may be prevented from being irregularly arranged. In one or more embodiments, the photonic crystal layer PC may be partitioned into a plurality of pixel areas by a set of barrier walls formed of an insulating material. In one or more embodiments, the particles and the solvent are disposed in pixel areas partitioned by the set of barrier walls, and thus the partitioned particles and the partitioned solvent may be prevented from being mixed with the partitioned particles and the partitioned solvent in adjacent pixel areas.

The second image display unit DP2 includes a plurality of pixels PXL2 arranged in a matrix form. The pixels PXL2 are distinguished from but correspond to the pixels PXL1 of the first image display unit DP1.

The second image display unit DP2 includes a third base substrate BS3, a fourth base substrate BS4 facing the third base substrate BS3, a liquid crystal layer LC disposed between the third base substrate BS3 and the fourth base substrate BS4, and a second electronic device that is configured to drive the liquid crystal layer LC.

Each of the third base substrate BS3 and the fourth base substrate BS4 may include, for example, a silicon substrate, a glass substrate, or a plastic substrate. The third base substrate BS3 and the fourth base substrate BS4 may be formed of one or more transparent materials. In the one or more embodiments, each pixel PXL2 includes a portion of the third base substrate BS3, a portion of the fourth base substrate BS4, a portion of the liquid crystal layer LC, and a portion of the second electronic device.

The portion of the second electronic device includes an electrode EL3, a portion of an electrode EL4, and a thin film transistor TFT2 (illustrated in FIG. 3B) electrically connected to the electrode EL3.

The electrode EL3 is disposed on the third base substrate BS3; the electrode EL4 is disposed on the fourth base substrate BS4. The electrode EL3 faces the electrode EL4 with a portion of the liquid crystal layer LC being disposed between the electrode EL3 and the electrode EL4. The electrode EL3 may be one of a plurality of electrodes EL3, wherein the electrodes EL3 (pixel electrodes) correspond to the pixels PXL2, respectively. The electrode EL4 (a common electrode) corresponds to the plurality of electrodes EL3 and covers a substantial portion of the fourth base substrate BS4. The thin film transistor TFT2 (illustrated in FIG. 3B) is disposed on the third base substrate BS3 and is electrically connected to the electrode EL3.

The display device may include signal lines configured to apply signals to the second electronic device. The signal lines may be configured to apply the signals to the thin film transistor TFT2 of the second electronic device.

FIG. 3B is a circuit diagram illustrating a portion of the second electronic device.

Referring to FIG. 3B, the signal lines may include a gate line GL2 and a data line DL2. The gate line GL2 extends in a first direction and is electrically connected to a gate electrode of the thin film transistor TFT2 to apply a gate signal to the gate electrode of the thin film transistor TFT2. The data line DL2 extends in a second direction crossing the first direction and is electrically connected to a source electrode of the thin film transistor TFT2 to apply a data signal to the source electrode of the thin film transistor TFT2. The thin film transistor TFT2 applies the data signal to the electrode EL3 in response to a gate-on signal, and thus a data voltage corresponding to the data signal is applied to the electrode EL3. The electrode EL4 is applied with a common voltage (which may have the same level as the common voltage applied to the electrode EL2) when the data voltage is applied to the electrode EL3 through the thin film transistor TFT2; thus, an electric field is formed between the electrode EL3 and the electrode EL4.

The liquid crystal layer LC transmits or reflects light incident thereto in response to the electric field to display an image.

The electrode EL3 and/or the electrode EL4 may be formed in an integrally-formed single plate body, but a domain divider may be provided in the electrode EL3 and/or the electrode EL4 so as to form a plurality of domains that controls the liquid crystal layer LC. In one or more embodiments, the electrode EL3 and/or the electrode EL4 may include a plurality of slits or protrusions. In one or more embodiments, the electrode EL3 may include a plurality of fine slits, and the electrode EL4 may include a plurality of branches.

In one or more embodiments, the electrode EL3 and the electrode EL4 are disposed on the third base substrate BS3 and the fourth base substrate BS4, respectively. In one or more embodiments, the electrodes EL3 and EL4 may be formed on one of the third base substrate BS3 and the fourth base substrate BS4. For example, the electrodes EL3 and EL4 may be disposed on the third base substrate BS3, and thus the second image display unit DP2 may be operated in a display mode using a horizontal electric field or a fringe field, such as an in-plane-switching (IPS) mode or a plane-to-line switching (PLS) mode.

In one or more embodiments, the pixels PXL1 may overlap the pixels PXL2 in a one-to-one correspondence (when viewed in a plan view of the display device). In one or more embodiments, the pixels PXL1 may not overlap the pixels PXL2. In one or more embodiments, the pixels PXL1 may correspond to the pixels PXL2 in a one-for-several correspondence (when viewed in a plan view of the display device).

Although not shown in FIGS. 1 and 2, one of the third base substrate BS3 and the fourth base substrate BS4 of the second image display unit DP2 may include color filters for enabling the light passing through the liquid crystal layer LC to show colors.

In one or more embodiments, the display device may include a backlight unit to provide the light to the second image display unit DP2. The second image display unit DP2 may be a non-self-light-emitting display device, and thus the second image display unit DP2 may require the backlight unit. The backlight unit is disposed adjacent to a side of the second image display unit DP2. The second image display unit DP2 may be a direct illumination type unit or an edge illumination type unit in accordance with the position of the backlight unit.

Hereinafter, a driving method of the display device will be described. First, an image display method of the first image display unit DP1 will be described.

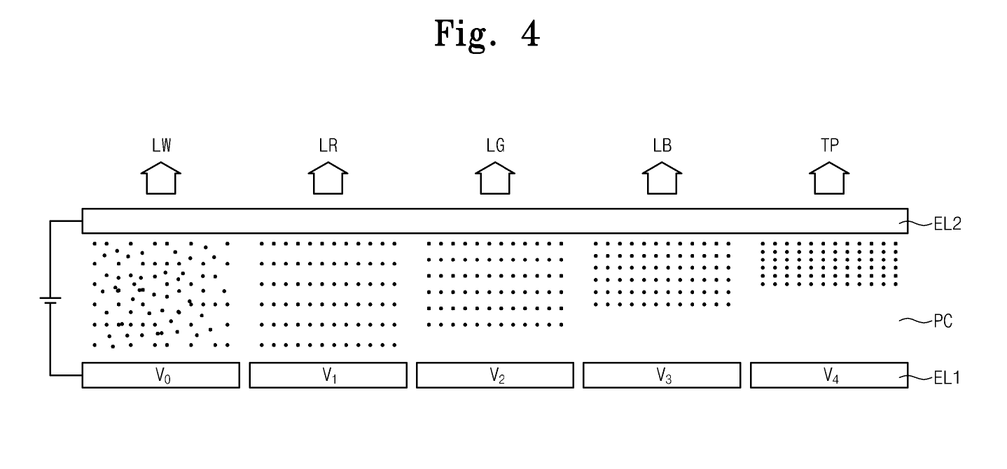

FIG. 4 is a view explaining operation of the first image display unit DP 1 of the display device according to one or more embodiments of the present invention. In FIG. 4, dots represent particles of the photonic crystal layer PC.

Referring to FIG. 4, the first image display unit DP1 may display different colors or may become transparent in accordance with the voltage applied to the photonic crystal layer PC. In FIG. 4, the electrodes EL1 (pixel electrodes) are applied with voltages V0, V1, V2, V3, and V4 as examples, and the electrode EL2 (a common electrode) is applied with a predetermined common voltage. In one or more embodiments, the voltages V0 to V4 have the levels of the order of V0<V1<V2<V3<V4, and the voltage V0 is the same voltage as the common voltage. When the voltage V0 is applied to the electrode ELL no electric field is formed between the electrode EL1 and the second electrode EL2, so that the particles of the photonic crystal layer PC are irregularly distributed. When the voltages V1 to V4 are applied to the electrodes ELL electric fields are formed between the electrodes EL1 and the electrode EL2, and thus the affected particles of the photonic crystal layer PC are regularly arranged. As the intensity of the electric field formed between an electrode EL1 and the electrode EL2 becomes strong, the distance between the affected particles becomes narrow. In one or more embodiments, when a voltage difference between an electrode EL1 and the electrode EL2 is equal to or greater than zero volts and smaller than about four (4) volts, the light is at least partially reflected or filtered by the particles that are regularly arranged. The resulted light may have a white color LW, a red color LR, a green color LG, or a blue color LB as indicated in FIG. 4 in accordance with the distribution of the particles and/or the distance between the particles. In one or more embodiments, when the voltage difference between an electrode EL1 and the electrode EL2 is equal to or greater than a predetermined voltage level, the affected portion of the photonic crystal layer PC may be transparent TP. This predetermined voltage level may be referred to as a transmission voltage, and the transmission voltage may be about four volts or more.

In one or more embodiments, when an electric field is applied to the photonic crystal layer PC, an electrical attractive force proportional to the intensity of the electric field and/or the charge amount of the particles may act on the particles. The affected particles may move toward the electrode EL1 or toward the electrode EL2 by the electrical attractive force, and thus the distances between the particles become narrow. Nevertheless, an electrical repulsive force between the particles may increase since the distances between the particles become narrow. Consequently, the electrical attractive force and the electrical repulsive force may reach a balance. In one or more embodiments, due to the electrical polarization property of the solvent, the polarization of the solvent is performed in a predetermined direction. Thus, the particles are arranged such that the electrical attractive force according to the electric field, the electrical repulsive force between the particles having the same polarity electrical charge, and the electrical attractive force according to the polarization may reach a balance (or equilibrium). In one or more embodiments, the particles, which are arranged spaced apart from each other with a controlled distance, serve as the photonic crystals. In one or more embodiments, since the wavelength of the light reflected by the regularly arranged particles is decided by the distances between the particles, the wavelength of the light reflected by the particles may be controlled by adjusting the distances between the particles. In one or more embodiments, the pattern of the wavelength of the reflected light (and/or the wavelength of the transmitted light) may be controlled by controlling one or more of the intensity and direction of the electric field, the size and mass of the particles, the refractive index of the particles and the solvent, the charge amount of the particles, the electrical polarization property of the solvent, and the concentration of the particles dispersed in the solvent.

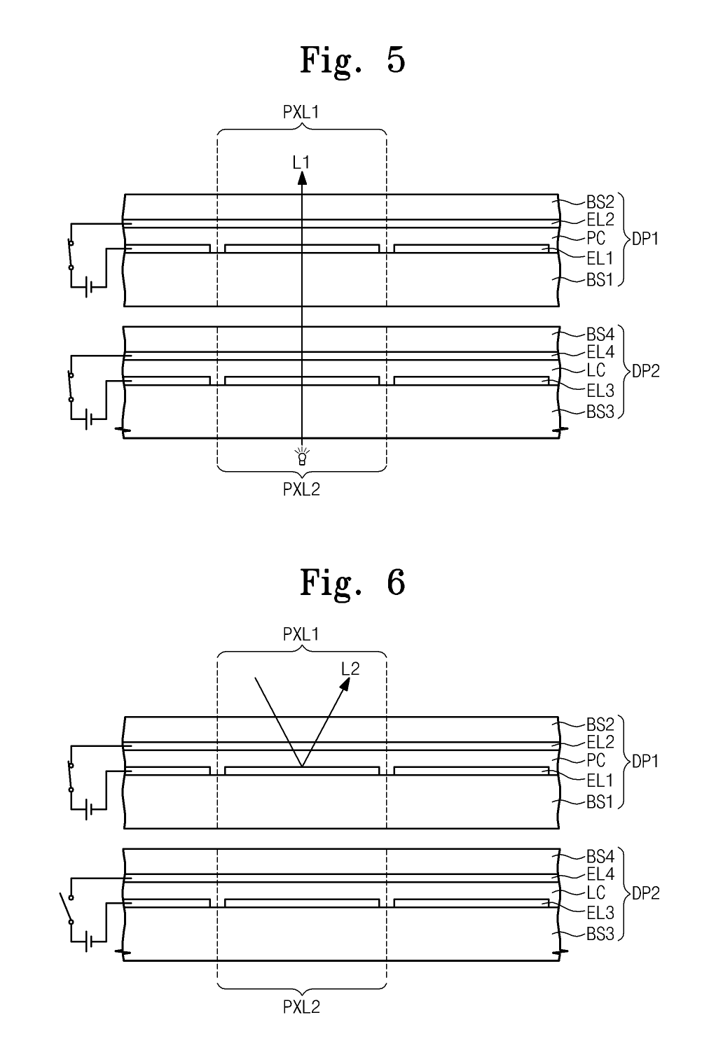

FIG. 5 is a cross-sectional view illustrating a display device operated in a transmission mode according to one or more embodiments of the present invention. FIG. 6 is a cross-sectional view illustrating a display device operated in a reflection mode according to or more embodiments of the present invention. Hereinafter, the transmission mode and the reflection mode will be referred to as a first mode and a second mode, respectively.

Referring to FIG. 5, the first image display unit DP1 and the second image display unit DP2 are turned on in the first mode (i.e., the transmission mode) of the display device.

When a pixel PXL1 of the first image display unit DP1 is turned on, the thin film transistor TFT1 is turned on in response to the driving signal provided through the gate line GL1. When the thin film transistor TFT1 is turned on, the image signal provided through the data line DL1 is applied to the electrode EL1 through the thin film transistor TFT1. Accordingly, an electric field is formed between the electrode EL1 and the electrode EL2, and corresponding portion of the photonic crystal layer PC is operated by the electric field. The electrodes EL1 and EL2 are applied with voltages such that the voltage difference between the electrodes EL1 and EL2 of the first image display unit DP 1 is equal to or greater than the transmission voltage. The other pixels PXL1 of the first image display unit DP1 may operate in an analogous manner. The first image display unit DP1 transmits light without displaying an image.

When a corresponding pixel PXL2 of the second image display unit DP2 is turned on, the thin film transistor TFT2 is turned on in response to the driving signal provided through the gate line GL2. When the thin film transistor TFT2 is turned on, the image signal provided through the data line DL2 is applied to the electrode EL3 through the thin film transistor TFT2. Accordingly, an electric field is formed between the electrode EL3 and the electrode EL4, and a corresponding portion of the liquid crystal layer LC is operated by the electric field. The liquid crystal layer LC transmits or blocks the external light (e.g., light provided by a backlight unit). The other pixels PXL2 of the second image display unit DP2 may operate in an analogous manner.

As a result, the light L1 provided from the backlight unit may sequentially pass through the second image display unit DP2 and the first image display unit DP1, and the viewer may perceive the image formed by the second image display unit DP2. In the transmission mode, the second image display unit DP2 may be positioned closer to the light source than the first image display unit DP1. For example, the second image display unit DP2 may be positioned between the light source and the first image display unit DP1.

Referring to FIG. 6, the first image display unit DP1 is turned on and the second image display unit DP2 is turned off in the second mode (i.e., the reflection mode) of the display device.

When a pixel PXL1 of the first image display unit DP1 is turned on, the thin film transistor TFT1 is turned on in response to the driving signal provided through the gate line GL1. When the thin film transistor TFT1 is turned on, the image signal provided through the data line DL1 is applied to the electrode EL1 through the thin film transistor TFT1. Accordingly, an electric field is formed between the electrode EL1 and the electrode EL2, and a corresponding portion of the photonic crystal layer PC is operated by the electric field. The electrodes EL1 and EL2 are applied with the voltages such that the voltage difference between the electrodes EL1 and EL2 of the first image display unit DP1 is smaller than the transmission voltage. Since the pixel PXL1 reflects the light having the wavelength in accordance with the intensity and direction of the electric field, the external light (e.g., ambient light) is reflected by pixel PXL1 to have a specific color by controlling the electric field formed between the electrodes EL1 and EL2 according to the image signal. For instance, if the voltage difference between the electrodes EL1 and EL2 is zero volts, the pixel PXL1 may reflect the external light to display the white color; if the voltage difference between the electrodes EL1 and EL2 is greater than zero volts and smaller than the transmission voltage, PXL1 may reflect the external light to display a specific color, e.g., the red color, the green color, or the blue color. Other pixels PXL1 may operate in analogous manners for displaying various colors according to corresponding image signals.

The second image display unit DP2 is turned off, and thus the second image display unit DP2 may not display any colorful image with various colors or may display a monochromatic background image.

In the second mode of the display device, the light L2 is incident to the first image display unit DP1 from the side of the viewer, and the display device (or the first image display unit DP1) reflects the light L2 in the second mode to display the image. The display device may operate in the reflection mode if there is sufficient ambient light, such that the second image display unit DP2 and/or the backlight unit may be turned off or may remain turned off for conserving energy. In the reflection mode, the first image display unit DP1 may be positioned closer to the light source than the second image display unit DP2. For example, the first image display unit DP1 may be positioned between the light source and the second image display unit DP2.

In one or more embodiments, the second image display unit DP2 may be a normally black mode display unit in which a black image is displayed when the display unit is turned off or may be a normally white mode display unit in which a white image is displayed when the display unit is turned off. In one or more embodiments, the second image display unit DP2 is a normally black mode display unit, and at least some of the pixels PXL1 of the first image display unit DP1 may have voltage differences equal to or greater than the transmission voltage. When the pixels PXL1 of the first image display unit DP1 have voltage differences equal to or greater than the transmission voltage, the pixels PXL1 become transparent, and the black image formed by the pixels PXL2 of the second image display unit DP2, which correspond to the pixels PXL1, may be clearly perceived by the viewer.

The display device may operate in the second mode (i.e., the reflection mode) when the ambient light, e.g., the light L2 illustrated in FIG. 6, is sufficient, and may operate in the first mode (i.e. the transmission mode) using the internal light, e.g., the light L1 provided by the backlight unit of the display device, when the ambient light is insufficient. Thus, the display device may provide the image with sufficient brightness to the viewer regardless of the amount of the ambient light. In addition, when the amount of the external light is sufficient, the second image display unit DP2 and/or the backlight unit may be turned off for reducing power consumption in the display device.

In one or more embodiments, the second image display unit DP2 may include one or more of various image display layers, such as an electrophoretic layer, an organic light emitting layer, an electrowetting layer, etc., instead of the liquid crystal layer LC.

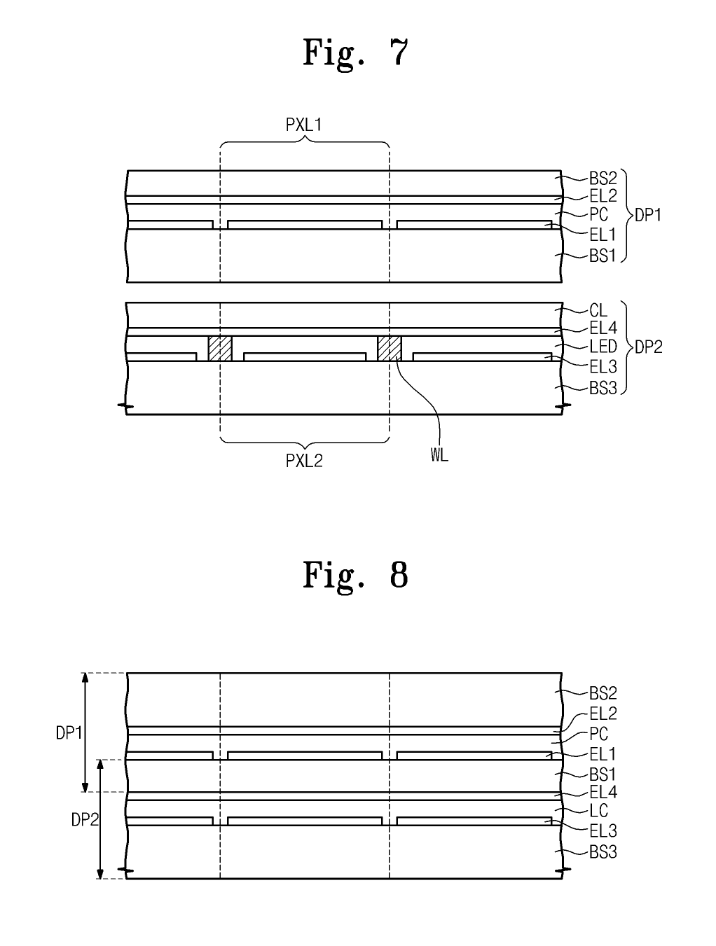

FIG. 7 is a cross-sectional view illustrating a display device according to one or more embodiments of the present invention. FIG. 7 illustrates that the second image display unit DP2 includes an organic light emitting layer LED. In FIG. 7, the same reference numerals may denote the same elements in FIG. 5, and thus detailed descriptions of the same elements may be omitted.

Referring to FIG. 7, the display device includes a first image display unit DP1 and a second image display unit DP2. The first image display unit DP1 and the second image display unit DP2 are stacked, and the first image display unit DP1 faces a viewer and is disposed between the viewer and the second image display unit DP2.

The first image display unit DP1 has a rectangular plate shape (with long sides and short sides) and includes a photonic crystal layer PC. The first image display unit DP1 includes a first base substrate BS1, a second base substrate BS2 facing the first base substrate BS1, the photonic crystal layer PC disposed between the base substrates BS1 and BS2, and a first electronic device that is configured to drive the photonic crystal layer PC.

The first electronic device includes a plurality of electrodes EL1 (pixel electrodes), an electrode EL2 (a common electrode), and a plurality of thin film transistors TFT1 (illustrated in FIG. 3A) connected to the electrodes EL1. Each of electrodes EL1 is disposed on the first base substrate BS1; the electrode EL2 is disposed on the second base substrate BS2. The electrodes EL1 face the electrode EL2 with the photonic crystal layer PC being disposed between the electrodes EL1 and the electrode EL2. The electrodes EL1 correspond to the pixels PXL1, respectively. The electrode EL2 is provided in an integrally-formed single plate body to cover at least a substantial portion the second base substrate BS2. Each thin film transistor TFT1 is disposed on the first base substrate BS1 and is connected to an electrode EL1.

The thin film transistor TFT1 applies the data signal to the electrode EL1 in response to a gate-on signal, and thus a data voltage corresponding to the data signal is applied to the electrode EL1. Meanwhile, the electrode EL2 is applied with a common voltage, and the data voltage is applied to the electrode EL1 through the thin film transistor TFT1, and thus an electric field is formed between the electrode EL1 and the electrode EL2.

The photonic crystal layer PC transmits or reflects light incident thereto in response to the electric field. The photonic crystal layer PC reflects a portion of the light, which has a specific wavelength, and transmits a remaining portion of the light, which has one or more other wavelengths, so as to display an image with a color. The photonic crystal layer PC includes particles having electric charges or an electric polarization property and includes a solvent. Accordingly, when the electric field is applied to the photonic crystal layer PC, a distance between the particles is controlled. As a result, the portion of the light having the specific wavelength is reflected by the photonic crystal layer PC, and the color image is displayed.

The second image display unit DP2 includes a third base substrate BS3, a barrier wall WL disposed on the third base substrate BS3 to define second pixels PXL2, an organic light emitting layer LED provided in the second pixels PXL2, a cover layer CL that covers the organic light emitting layer LED, and a second electronic device is configured to drive the organic light emitting layer LED.

The second electronic device includes a plurality of electrodes EL3 (pixel electrodes), an electrode EL4 (a common electrode), and a plurality of thin film transistors TFT2 (illustrated in FIG. 3B) connected to the plurality of electrodes EL3.

The electrode EL3 is disposed on the third base substrate BS3; the electrode EL4 is disposed on the organic light emitting layer LED. The electrode EL3 faces the fourth electrode EL4 with a portion of the organic light emitting layer LED disposed between the electrode EL3 and the EL4. The electrode EL3 may be one of a plurality of electrodes EL3, wherein the electrodes EL3 are spaced apart from each other and correspond to the pixels PXL2, respectively. The electrode EL4 is provided in an integrally-formed single plate body to cover at least a substantial portion of the organic light emitting layer LED and the barrier wall WL. The thin film transistor TFT2 (illustrated in FIG. 3B) is disposed on the third base substrate BS3 and is connected to the electrode EL3. The cover layer CL is disposed on the electrode EL4 to cover the electrode EL4 and elements disposed thereunder.

The thin film transistor TFT2 applies the data signal to the electrode LE3 in response to the gate-on signal, and thus the electrode EL3 is applied with the data voltage. One of the electrode EL3 and the electrode EL4, which has a relatively small work function, serves as a cathode; the other one of the electrode EL3 and the electrode EL4, which has a relatively large work function, serves as an anode. Electrons from the cathode make contact with holes from the anode in the organic light emitting layer LED, and thus the organic light emitting layer LED emits the light, thereby displaying the image.

The display device may operate in the first mode (i.e., a transmission mode) and the second mode (i.e., a reflection mode). In the first mode of the display device, the image display units DP1 and DP2 are turned on to display the image. The second image display unit DP2 is a self-light-emitting display unit, which does not need to have a separate light source, e.g., a backlight unit. In the second mode of the display device, the first image display unit DP1 is turned on, and the second image display unit DP2 is turned off.

FIG. 8 is a cross-sectional view illustrating a display device according to one or more embodiments of the present invention. In one or more embodiments, the display device includes a first display unit DP1 and a second image display unit DP2 integrally formed with each other. In FIG. 8, the same reference numerals may denote the same elements in FIG. 7, and thus detailed descriptions of the same elements may be omitted.

Referring to FIG. 8, the display device includes a first image display unit DP1 and a second image display unit DP2. In the display device, the first image display unit DP1 and the second image display unit DP2 share a first base substrate BS1.

That is, the first image display unit DP1 includes the first base substrate BS1, a second base substrate BS2 facing the first base substrate BS1, a photonic crystal layer PC disposed between the first and second base substrates BS1 and BS2, and a first electronic device that is configured to drive the photonic crystal layer PC.

The second image display unit DP2 includes a third base substrate BS3, the first base substrate BS1 facing the third base substrate BS3, a liquid crystal layer LC disposed between the third base substrate BS3 and the first base substrate BS1, and a second electronic device that is configured to drive the liquid crystal layer LC.

The first electronic device includes a plurality of electrodes EL1, an electrode EL2, and a plurality of thin film transistors electrically connected to the electrodes EL. The second electronic device includes a plurality of electrodes EL3, an electrode EL4, and a plurality of thin film transistors electrically connected to the electrodes EL3.

Accordingly, the thickness of the display device may be minimized, and the manufacturing cost of the display device may be reduced since the number of the base substrates is reduced.

Although embodiments of the present invention have been described, it is understood that the present invention should not be limited to these embodiments, but various changes and modifications can be made by one ordinary skilled in the art within the spirit and scope of the present invention as hereinafter claimed.

What is claimed is:

1. A display device capable of operating in a first mode and capable of operating in a second mode, the display device comprising:
a first image display unit including a photonic crystal layer, the photonic crystal layer being configured to be substantially transparent when the display device operates in the first mode and being configured to display at least an image when the display device operates in the second mode;
a second image display unit overlapping the first image display unit and configured to be turned on in the first mode to display at least an image and turned off in the second mode.

2. The display device of claim 1, wherein the second image display unit is configured to display a monochromatic image when the first image display unit displays one or more images.

3. The display device of claim 1, wherein
the first image display unit includes a first pixel electrode and a first common electrode,
the first pixel electrode is configured to receive a first data voltage,
the first common electrode overlaps the first pixel electrode and is configured to receive a first common voltage,
at least a portion of the photonic crystal layer is disposed between the first pixel electrode and the first common electrode, and
one of the first pixel electrode and the first common electrode is disposed between the photonic crystal layer and the second image display device.

4. The display device of claim 3, wherein
the second image display unit includes a second pixel electrode and a second common electrode,
the second pixel electrode overlaps the first pixel electrode and is configured to receive a second data voltage,
the second common electrode is configured to receive a second common voltage, and
the portion of the photonic crystal layer is disposed between one of the first pixel electrode and the first common electrode and at least one of the second pixel electrode and the second common electrode.

5. The display device of claim 4, wherein
the second pixel electrode is configured to receive the second data voltage when the first image display unit is substantially transparent, and
the second pixel electrode is configured to receive no data voltage when the first image display unit displays one or more images.

6. The display device of claim 4, wherein
the second image display unit includes an organic light emitting layer, and
one of the second pixel electrode and the second common electrode is disposed between the photo crystal layer and the organic light emitting layer.

7. The display device of claim 4, wherein
the second image display unit includes a liquid crystal layer, and
one of the second pixel electrode and the second common electrode is disposed between the photo crystal layer and the liquid crystal layer.

8. The display device of claim 3, further comprising a base substrate, wherein
one of the first pixel electrode and the first common electrode is disposed on the base substrate, and
one of the second pixel electrode and the second common electrode is disposed on the base substrate.

9. The display device of claim 3, wherein
the first data voltage has a first voltage level when the display device operates in the first mode,
the first data voltage has a second voltage level when the display device operates in the second mode, and
the first voltage level is greater than the second voltage level.

10. The display device of claim 3, wherein
a difference between the first data voltage and the first common voltage has a first absolute value when the display device operates in the first mode,
the difference between the first data voltage and the first common voltage has a second absolute value when the display device operates in the second mode, and
the first absolute value is greater than the second absolute value.

11. The display device of claim 3, wherein
the second image display unit includes an organic light emitting layer, and
one of the first pixel electrode and the first common electrode is disposed between the photo crystal layer and the organic light emitting layer.

12. The display device of claim 3, wherein the portion of the photonic crystal layer is configured to reflect light of various wavelengths according to various values of a difference between the first data voltage and the first common voltage when the display device operates in the second mode.

13. The display device of claim 1, further comprising a light-emitting unit that is disposed closer to the second image display unit than to the first image display unit.

14. The display device of claim 1, wherein the display device is configured to be used by a viewer that is positioned closer to the first image display unit than to the second image display unit.
